(19) United States
(12) Patent Application Publication
(10) Pub. No.: US 2024/0059249 A1
(43) Pub. Date: Feb. 22, 2024

(54) METHOD FOR AUTHENTICATING A USER, A SYSTEM AND A TRANSPORTATION VEHICLE

(71) Applicant: VOLKSWAGEN AKTIENGESELLSCHAFT, Wolfsburg (DE)

(72) Inventors: Bernd ETTE, Wolfsburg (DE); Tim WOLLENTIN, Braunschweig (DE); Ditmar FRANZ, Peine (DE)

(21) Appl. No.: 18/448,954

(22) Filed: Aug. 13, 2023

(30) Foreign Application Priority Data
Aug. 22, 2022 (DE) 10 2022 208 670.8

(51) Int. Cl. B60R 25/24; B60R 25/01; G07C 9/00

(52) U.S. Cl. CPC B60R 25/245; B60R 25/01; G07C 9/00309; B60R 2325/101; B60R 2325/103; G07C 2009/00793; G07C 2209/63

(57) ABSTRACT

A method for authenticating a user of a transportation vehicle, a system to perform the method and a transportation vehicle equipped with the system. A position and/or a movement gradient of an authorized user is/are determined based on received impulse responses of emitted UWB impulses and/or based on a result of channel impulse response (CIR) measurements using UWB signals, and the authorized user is authenticated based on this information.

### PRIORITY CLAIM

This patent application claims priority to German Patent Application No. 10 2022 208 670.8, filed 22 Aug. 2022, the disclosure of which is incorporated herein by reference in its entirety.

### SUMMARY

Illustrative embodiments relate to a method for authenticating a user of a transportation vehicle, a system to carry out the method, and a transportation vehicle comprising the system.

### BRIEF DESCRIPTION OF THE DRAWINGS

Disclosed embodiments are explained below with reference to the drawings, in which:

FIG. 1 shows a schematic representation of a disclosed method of a transportation vehicle according to an exemplary embodiment;

FIG. 2 shows a schematic view of a disclosed transportation vehicle according to an exemplary embodiment; and

FIG. 3 shows a schematic view of a disclosed system according to an exemplary embodiment.

### DETAILED DESCRIPTION

To enable keyless access to a transportation vehicle, modern transportation vehicles have different systems which can identify mobile terminal devices or transponders of users in the transportation vehicle environment on the basis of radio technologies.

One example of a system which enables passive access to a transportation vehicle is described in document US 2020/247363 A1. The system disclosed there sets up a BLUETOOTH® Low Energy (BLE) or ultra-wideband (UWB) communication connection to a portable device. The system transmits a request to the portable device via a low-frequency transmitter and receives a corresponding response. The system authorizes the portable device on the basis of the information contained in the received response. In response to the authorization of the portable device, the system performs a vehicle function, including the unlocking of a door of the transportation vehicle, the unlocking of a trunk of the transportation vehicle or the enabling of the starting of the transportation vehicle.

A common problem here is that the systems that are used cannot reliably authenticate the source of the received radio signal, i.e., whether the received radio signal actually originates from the user or originates from a source that has obtained the information of the radio signal by criminal energy. To deal with security issues of this type, modern systems query position data and movement data of the portable device to locate the user in this way and authenticate the user on the basis of the location information.

Known systems for locating users for the purpose of authentication are described in documents DE 10 2017 201 308 A1, DE 10 2022 100 583 A1 or DE 10 2020 103 083 A1.

However, when locating users for their authentication, the known systems are reliant on the mobile terminal devices or transponders of the users being suitable for setting up corresponding radio communication and for acquiring suitable position data and movement data. The problem here is that a multiplicity of older models of mobile terminal devices which do not usually meet corresponding requirements are present on the market. They either lack the necessary hardware or the software that is used is outdated and therefore not capable, for example, of setting up communication with the system of the transportation vehicle or of providing location information. This relates, in particular, to devices which do no enable either UWB communication or modern BLUETOOTH® communication (in particular, at least BLUETOOTH® standard version 5.1). The direction-finding function enabling devices to identify the direction of objects, inter alia, was introduced with BLUETOOTH® version 5.1.

The disclosed embodiments provide a method which allows authentication of a larger number of users, and a system to carry out the method.

This is achieved by a method for authenticating a user of a transportation vehicle, by a system to carry out the method, and by a transportation vehicle having the disclosed system.

At least one exemplary embodiment relates to a method for authenticating a user of a transportation vehicle. The transportation vehicle has two modules designed to detect the position of a user, in each case having a transceiver, in each case with an antenna, configured to transmit and receive UWB and BLUETOOTH® signals, in particular, BLE signals. The transceiver is designed, in particular, to transmit and receive signals in very wide frequency ranges, in particular, in a frequency range from 2.4 to 10.6 GHz. In the case of UWB signals, the transceiver may be designed to transmit and receive signals in a frequency range from 3.5 to 9 GHz, particularly, in a frequency range from 6 GHz to 8.5 GHz. BLUETOOTH® communication may take place in the known frequency band between 2.402 GHz und 2.480 GHz. BLUETOOTH® Low Energy radio technology may be provided.

The transmit power of the UWB impulses is low. The bandwidth of the UWB signal is at least 500 MHz and the UWB transceiver may be designed to transmit signals with a transmit power between 0.5 mW/−41.3 dBm/MHz. The transceiver, may furthermore be designed in accordance with the IEEE 802.15.4 standard (in particular, the sections relating to the UWB PHY Layer) and optionally in accordance with the IEEE 802.15.4z standard. UWB signals interfere only minimally with other radio signals due to the dispersion of the signals over wide frequency ranges of this type.

A radio signal for authorizing the user transmitted via an external transceiver is received using at least one of the antennas. In other words, the user transmits a command signal, including authorization information, to the transportation vehicle using his mobile terminal device or a transponder to perform one of the transportation vehicle functions known per se. This communication may take place at least on the basis of UWB and/or BLUETOOTH® radio technology.

The transceiver is activated to transmit UWB impulses and to receive impulse responses using at least one of the antennas, and/or to carry out a method based on channel impulse response (CIR) measurements using the antennas. The position and/or a movement gradient of the user is/are determined on the basis of the received impulse responses and/or a result of the CIR measurements. In the CIR measurements, one antenna transmits a UWB signal to another antenna which receives the transmitted signal, whereas, in the method with the received impulse responses, the same antenna that transmitted the UWB signal also receives the impulse response. In this respect, an echo of the scanned environment is received. In other words, the user is located based on UWB radio technology without the need for communication between the transportation vehicle and the external transceiver. Consequently, users with mobile terminal devices in the immediate vicinity of the transportation vehicle who use a mobile terminal device or transponder which has neither UWB-enabled communication nor the necessary BLUETOOTH® standard in the version from 5.1 can also be located.

Due to the temporally highly localized UWB impulses, it is possible to extract information relating to the propagation path of the UWB impulses from received UWB impulses with their impulse response resulting from the influence of the environment on the transmitted UWB impulse. Environmental influences are based on physical phenomena which deflect the UWB impulse from its geometrically prescribed path, such as, for example, refraction, diffraction, reflection or attenuation. The delays of the signals or signal packets along different propagation paths obviously differ from one another and change depending on the presence or absence of objects in or near the propagation paths. The impulse shape of the signals or signal packets is also influenced depending on the presence or absence of objects in or near the propagation paths. The presence or absence of objects in or near the propagation paths can be inferred on the basis of the measurement of signals or signal packets transmitted along these propagation paths.

In the case of a received impulse response of a UWB impulse transmitted by the same antenna, this impulse response replicates a multiplicity of temporally resolved echo signals which manifest themselves in the impulse response depending on the distance between these objects and/or persons and the transceiver. Inferences can be made regarding location changes of the objects and/or persons in relation to the transceiver by comparing the echo signals over temporally offset UWB impulses and their received impulse responses. The movement gradients can be determined from the location changes. The echo signals may be determined and compared with one another on the basis of amplitude information and/or phase information. As a result, it is possible to scan the environment or the passenger compartment of the transportation vehicle using at least one antenna in a location-resolved and time-resolved manner. The antennas of the two modules or antennas or of further modules can obviously also carry out the received impulse response method to scan the environment and/or the passenger compartment of the transportation vehicle in a location-resolved and time-resolved manner.

The further away an object is from the transceiver, the later the echo signal assigned to the object will be received by the transceiver. A range of the transceiver can thus be restricted by interrupting a reception of the impulse response after a time corresponding to the desired range, and/or by transmitting a new UWB impulse. No reception of the impulse response by the transceiver used for transmission is possible in the time in which the UWB impulse is transmitted via the transceiver.

Additionally or alternatively, it is further possible to scan the environment by the CIR measurements in a location-resolved manner using at least two antennas. Changes in the environment—for example, an object newly located in the area to be scanned—can be made visible by comparing the time-offset impulse responses in a location-resolved and time-resolved manner through multiple transmission of UWB impulses via one of the antennas and on the basis of the impulse responses received by the other antenna. An object entering the area to be scanned can be reliably detected in this way. In particular, a constant and repetitive scanning of the environment by CIR measurements allows corresponding monitoring of the area to be scanned.

The CIR measurements comprise, for example, transmitting predefined signals or signal packets (referred to as messages) between the (at least) two antennas. Along with a direct propagation path of the signal or the signal packets between the antennas, a multiplicity of further propagation paths exist which, for example, include reflections of objects from the passenger compartment or external space of the transportation vehicle. On the basis of a sufficient number and/or a sufficient arrangement of the antennas, these propagation paths enable coverage of large parts of a space, for example, a passenger compartment of a transportation vehicle or an external space of a transportation vehicle. The CIR measurements can obviously be carried out between a multiplicity of modules to scan corresponding areas depending on the arrangement of the modules.

The user is further authenticated by assigning the user to the received radio signal on the basis of the determined position and/or the determined movement gradient of the user. The modules, due to their predefined arrangement in the transportation vehicle, comprise a predetermined authentication area within which the user must be present to be authenticated by the transportation vehicle. The range of the authentication area may be definable by the defined range of the transceiver and/or is dependent on the arrangement of the antennas for the CIR measurements. The direction in which the user is moving and whether the user is performing a gesture movement that is stored in a storage unit may be determined using the movement gradients. Users, for example, who are moving in a direction away from the transportation vehicle and/or at most parallel to the transportation vehicle direction can be excluded from the authentication. Only users who are moving in a direction toward the transportation vehicle, i.e., users who, with a higher probability, wish to interact with and/or get into the transportation vehicle, are then authenticated. Gestures of the user may be determined from the determined movement gradients to enable an operation of the transportation vehicle or an authentication of the user by a gesture movement. The transportation vehicle can consequently be operated contactlessly by hand or gesture and/or by the mobile terminal device and/or the transponder. The respectively described benefits come into effect through the combination of the authentication area with the determined direction of movement of the user. Communication beyond the authorization between the transportation vehicle and the external transceiver is therefore not required according to the disclosure. Users of mobile terminal devices which are outdated or unsuitable for other reasons can also be authenticated on the basis of the determined position data and/or movement data, so that a larger user group can be addressed.

In at least one exemplary embodiment, it is provided that the transceivers of the two modules are activated to carry out a positioning method based on delay measurements using the antennas to determine a position of the external transceiver, wherein the user is further authenticated by matching the determined position and/or the determined movement gradient of the user with the determined position of the external transceiver. The time of arrival (TOA), the time of flight (TOF), the two-way ranging (TWR), the time difference on arrival (TDOA), the angle of arrival (AOA), the angle of departure (AOD) and/or the received signal strength indication (RSSI) may be provided as positioning methods. UWB and/or BLUETOOTH® technology may be provided for the purposes of the positioning method. In other words, the external transceiver is located here by radio communication between the transportation vehicle and the external transceiver. The position information can be verified (matched) with the determined position data and/or movement data of the user via the external transceiver, and the probability of incorrect authentications can thus be reduced. In the case of mobile terminal devices which use the BLUETOOTH® standard in a version below 5.1, an RSSI measurement may be carried out and its result is verified (matched) with the determined position data and movement data of the user.

In a further exemplary embodiment, it is provided that at least one or both of the transceivers further comprise(s) a near-field communication (NFC) antenna which is configured to transmit and receive NFC radio signals, and to receive the radio signal for authorizing the user as an NFC radio signal. Authorization data can also be received via the NFC antenna from the mobile terminal devices or transponders which are unable to set up either UWB or BLUETOOTH® communication with the transportation vehicle. Due to the short range of NFC, from a few centimeters to at most 10 cm, the user can easily be authenticated using the determined position and/or the determined movement gradients of the user. In other words, only a small authentication area corresponding to the range of NFC within which the user must be located to be authenticated by the transportation vehicle may be chosen if an NFC data transmission is identified. The at least one transceiver may be configured to transmit electromagnetic energy onto the internal transceiver by the antenna. Authorization data can therefore be transmitted via NFC, even if the battery of the mobile terminal device and/or of the transponder is discharged.

In a further exemplary embodiment, it is provided that an authorization status of the authenticated user is determined on the basis of the received radio signal and a database stored in a memory. The authorization and subsequent authentication of the user by the transportation vehicle can be performed by a central system. The transportation vehicle does not have to be equipped with different systems and costs can be saved.

The two modules may be activated to transmit a request for a payment procedure using the antennas and/or the at least one NFC antenna if the determined position of the authenticated user falls below a predetermined distance to the transportation vehicle. A confirmation signal to carry out the payment procedure may be received using the antennas and/or the at least one NFC antenna, and the authorization status of the authenticated user is adjusted on the basis of the received confirmation signal. In other words, the transportation vehicle is designed to take charge of payment functions using one or more modules. The transportation vehicle does not have to be equipped with different systems and costs can be saved. The predetermined distance may be at most 5 m, optionally at most 2.5 m, or optionally 0.1 to 1.5 m. The maximum distance of 1.5 m of the devices communicating with one another necessary for the payment function is ensured by the determination of the position and/or of the movement gradients according to the disclosure, and a reliable payment function is therefore implemented by one system only.

The transportation vehicle optionally performs at least one vehicle function based on the authorization status of the authenticated user. One or more vehicle doors and/or at least one vehicle window the transportation vehicle are opened or closed on the basis of the authorization status of the authenticated user. The vehicle function is performed selectively in that it is permitted for the authorized and authenticated users only.

In a further exemplary embodiment, it is provided that the modules are arranged in such a way that the activation of the transceivers to carry out the method based on the channel impulse response measurements and/or the transmission of the UWB impulses and reception of the impulse responses are carried out in such a way that at least one access area to the transportation vehicle is scanned. The access area is the area of the transportation vehicle in which the user can get in or out of transportation vehicle. This is the area around an entry door of the transportation vehicle. The method can be applied to all design types of the doors, such as sliding doors or hinged doors. The access area optionally comprises the area of the door in the closed state, plus an adjacent area which extends for three meters, optionally two meters, or optionally one meter, into and/or out from the transportation vehicle. The scanning of the access area offers the benefit that the user can authorized and authenticated automatically, so that the user can enter the transportation vehicle comfortably and effortlessly. In other words, the access authorization can take place automatically with passive access of the user. Particular benefits are therefore gained in the case of (driverless) self-driving transportation vehicles. A possible collision of the closing driver's door with the user can further be detected in a timely manner and the closing procedure can be interrupted.

The authentication area may be dependent on a state of the entry door and/or a position of the transportation vehicle. With the entry door in a closed state, and when arriving at a stopping place, for example, the range of the authentication area can be greater than with the entry door in an open state. This takes account of the circumstance in which a user wishing to enter the transportation vehicle approaches the transportation vehicle when a door is open. When the transportation vehicle arrives at a stopping place with a wide-range authentication area, it is beneficial if the transportation vehicle knows at a very early stage which or how many users wish to board the transportation vehicle at the stopping place. In this case, the transportation vehicle can perform predetermined vehicle functions to interact with the user(s), in particular, to present information on a human display interface of one of the modules. The seat occupancy, for example, and further stopping places to be visited are displayed. In addition, however, it is also possible to indicate that a UWB or BLUETOOTH® connection could not be set up to the user and the user should perform the communication using NFC. The CIR measurements and/or the measurements based on received impulse responses may be carried out only on arrival at a stopping place and/or as soon as a user authorized by UWB, BLUETOOTH® or NFC is located in the surrounding area of the transportation vehicle.

The modules may comprise a CAN Interface to be interconnectable. A signal to initiate a start phase may be transmitted via the CAN interface to determine the position and/or the movement gradient of the user. At least one of the modules similarly comprises an interface for communication with the user (Human Machine Interface—HMI). The HMI optionally displays real-time data and/or enables the user to perform inputs via a graphical interface for communication with the transportation vehicle. The modules may be arranged in an area of the transportation vehicle visible to the user. An area visible to the user is, for example, a window, in particular, a window in the entry door, a backrest, a headrest or a door panel. The windows can be trapezoid windows or fixed windows.

A further exemplary embodiment relates to a system which is designed to carry out the disclosed method. The system has a first and a second module configured to detect a position of a user, in each case with a transceiver having an antenna configured to transmit and receive UWB and BLUETOOTH® signals. The system further comprises a control unit connected to the transceivers which is configured to receive a radio signal transmitted via an external transceiver to authorize the user using at least one of the antennas, to activate the transceivers to transmit UWB impulses and to receive impulse responses using at least one of the antennas and/or to carry out a method based on channel impulse response (CIR) measurements using the antennas, to determine a position and/or a movement gradient of the user on the basis of the received impulse responses and/or a result of the CIR measurements, and to authenticate the user by assigning the user to the received radio signal on the basis of the determined position and/or the determined movement gradient of the user. The features described with the method and their benefits can similarly be implemented with the system and are therefore combinable with one another in any given manner.

Although the system has been described in relation to a form of application in a transportation vehicle, it is not restricted thereto. The system can instead be used in all applications in which an access authorization to control a door, tailgate, window and the like is additionally intended to be authenticated.

A further exemplary embodiment relates to a transportation vehicle which has the aforementioned system. The two modules are arranged on a vehicle side of the transportation vehicle which has an access area for entering and exiting the transportation vehicle. The features described with the method and their benefits can similarly be implemented with the transportation vehicle and are therefore combinable with one another in any given manner.

In at least one exemplary embodiment, it is provided that at least one of the two modules is arranged at a distance of at most 20 cm from the access area. The modules may be arranged on opposite sides of the entry door and/or one of the modules is arranged centrally and the other module is arranged on one of the opposite sides.

The aforementioned control unit of the transportation vehicle may be implemented by electrical or electronic components (hardware) or by firmware (ASIC). Additionally or alternatively, the functionality of the control unit is implemented with the execution of a suitable program (software). The control unit may be similarly implemented by a combination of hardware, firmware and/or software. Individual components of the control unit are designed, for example, as a separately integrated circuit to provide individual functionalities, or are arranged on a common integrated circuit.

The individual components of the control unit may be designed as one or more processes which run on one or more processors in one or more electronic computing devices and are generated with the execution of one or more computer programs. The computing devices may be designed to interwork with other components, for example, the modules, a central locking, a motor controller, etc., to implement the functionalities described herein. The instructions of the computer programs may be stored in a memory, such as, for example, a RAM element. However, the computer programs can also be stored in a non-volatile storage medium, such as, for example, a CD-ROM, a flash memory or the like.

It is furthermore evident to a person skilled in the art that the functionalities of a plurality of computers (data processing devices) can be combined or can be combined in a single device, or that the functionality of a specific data processing device can be provided as distributed among a multiplicity of devices to implement the functionality of the control unit.

A further exemplary embodiment relates to a computer program comprising instructions which, when the program is executed by a computer, such as, for example, a control device of a transportation vehicle having a system with a first and a second module configured to detect a position of a user, in each case with a transceiver having an antenna configured to transmit and receive UWB and BLUETOOTH® signals, prompt the latter to carry out the disclosed method, in particular, a method for authenticating a user of a transportation vehicle.

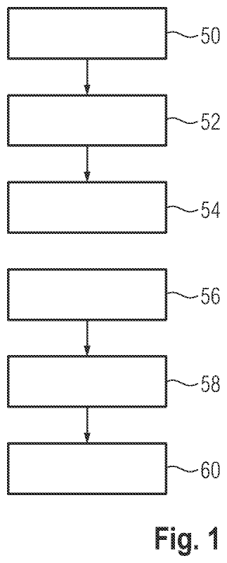

FIGS. 1 to 3 show schematic representations of a method, system and transportation vehicle proposed herein, which enable authentication of a larger number of users of a transportation vehicle.

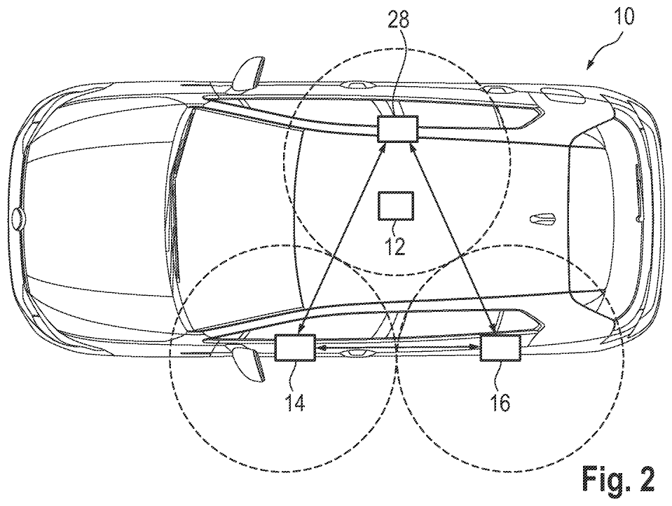

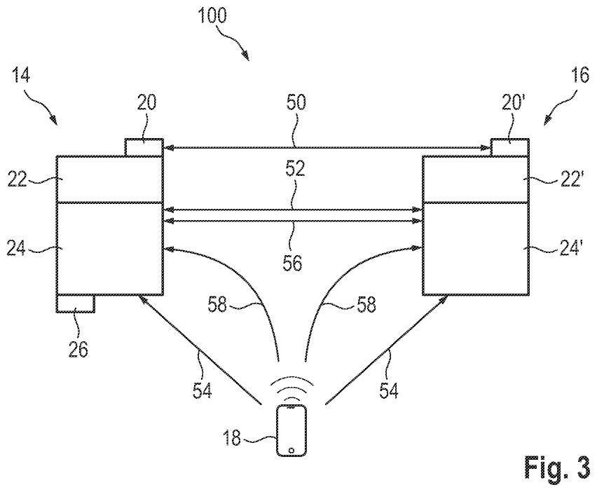

The method shown schematically in FIG. 1 is suitable for authenticating a user of a transportation vehicle 10 (see FIG. 2). The method is described in connection with the transportation vehicle 10 shown in FIG. 2 and the system 100 shown in FIG. 3.

The transportation vehicle 10 has a first and a second module 14, 16 configured to detect a position of a user. Each module 14, 16 comprises a transceiver 22, 22′ (see FIG. 3) which in turn comprises an antenna 24, 24′ configured to transmit and receive UWB and BLUETOOTH® signals. The two modules 14, 16 are arranged, by way of example on the left side of the transportation vehicle 10. To be precise, the first module 14 is fitted centrally in the window of the driver's door and in the door panel, whereas the second module 16 is arranged in a trapezoid window of the rear left vehicle door and its interior lining. In addition, a structurally identical third module 28 is arranged, by way of example, on the opposite side of the transportation vehicle 10 (right side) in the pillar between the front and rear door of the transportation vehicle 10. This is shown merely by way of example to enable a better understanding of the present disclosure.

The transportation vehicle 10 further comprises a control unit 12 connected to the transceivers 20, 22′, which is configured to receive a radio signal emitted via an external transceiver 18 (see FIG. 3) to authorize the user using the antennas 24, 24′ of the modules 14, 16, 28. The control unit 12 is further configured to activate the transceivers 22, 22′ to transmit UWB impulses and to receive impulse responses using at least one of the antennas 24, 24′ and to carry out a method based on channel impulse response (CIR) measurements using the antennas, and to determine a position and a movement gradient of the user on the basis of the received impulse responses and a result of the CIR measurements. The CIR measurements differ from the received impulse responses in that they transmit messages between the modules 14, 16, 28 which are modified in terms of their propagation path by objects in the environment of the message. In other words, an emitted UWB signal of a module and its changes on the propagation path are received by a different module (see arrows in FIG. 2 between the modules 14, 16, 28).

Conversely, in the received impulse response method, the UWB signal emitted by the antenna 24, 24′ is received by the same antenna 24, 24′. The environment is thus scanned by a type of echo signal of the environment. An example range of the modules 14, 16, 28 when this method is used is indicated in FIG. 2 by the dashed circles. This is intended merely by way of example for explanatory purposes. However, the circles, which have a radius of approximately one meter are not restricted to this dimension specification. Instead, ranges of up to 10 meters from the respective module 14, 16, 28 can also be achieved with this method.

The arrangement of the modules 14, 16 and 28 shown by way of example in FIG. 2 offers the benefit that the passenger compartment of the transportation vehicle can be scanned not only by CIR measurements between the module 28 with the module 14 and the module 16, but also by a method based on received impulse responses with the module 28. At the same time, however, a scanning of the left environment of the transportation vehicle 10 by a method based on received impulse responses with the modules 14 and 16 and of a left access area of the transportation vehicle 10 by CIR measurements between the modules 14 and 16 is also possible. Consequently, passengers getting in and out of the transportation vehicle (users of the transportation vehicle 10) can be identified with the modules 14 and 16, which are arranged along the direction of the transportation vehicle and the left-hand doors, on the basis of the determined movement gradient. The benefits specified here are obviously also achievable by other arrangements of the modules 14, 16, 28, in particular, on the other vehicle sides of the transportation vehicle 10 or by a different number of modules.

The control unit 12 is further configured to identify the user by assigning the user to the received radio signal on the basis of the determined position and/or the determined movement gradient of the user. The user authorized by the received radio signal is thus authenticated if the determined position and the determined movement gradient of the user are plausibly assignable to the received radio signal.

The system 100 described in FIG. 3 comprises the two modules 14 and 16 described with the transportation vehicle 10. Each of the modules 14, 16, comprises a CAN interface 20, 20′ to interconnect the modules 14, 16. The connection via the CAN interfaces 20, 20′ is used to initiate a start phase of the method (first method operation at 50 in FIG. 1). A start phase is initiated by the transportation vehicle 10 if, for example, the transportation vehicle arrives at predefined route points such as stopping places.

After the start phase, the antennas 24, 24′ are synchronized (second method operation at 52) and the radio signal is received from the external transceiver 18 of the user (third method operation at 54). Depending on the design of the external transceiver 18, the system 100 is not only capable of setting up UWB and/or BLUETOOTH® communication with the external transmitter 18. Moreover, at least the module 14 comprises an NFC antenna 26 to communicate with the external transceiver 18 via NFC. As a result, users who do not use a UWB-enabled or BLUETOOTH®-enabled mobile device (external transceiver 18) can also be authorized.

After the authorization data of the user have been received via the radio signal by the system 100, the system 100 performs CIR measurements and carries out the received impulse response method with the modules 14, 16. The position and the movement gradients of the user are determined on the basis of the received impulse responses and a result of the CIR measurements (fifth method operation at 58). With this form of location of the user, no communication between the external transceiver 18 and the system 100 is necessary, so that the users are located regardless of the mobile device that they use, such as a smartphone or transponder. In particular, the previously problematic location of devices having a BLUETOOTH® standard version below 5.1 is possible as a result. Even users of devices which are only NFC-enabled can thus be located by the system 100.

The user is assigned to the received radio signal for authorization of the user on the basis of the determined position and the determined movement gradients of the user (sixth method operation at 60), so that the authorized user is authenticated. The system 100 enables access to the transportation vehicle 10, for example, through the opening or unlocking of a vehicle door. Depending on the specific application of the system 100, other vehicle functions such as an actuator connected to the tailgate or to the vehicle window can be operated once the authorization and authentication of the user are completed. The method proposed herein, the system 100 and the transportation vehicle 10 comprising the system 100 thus enable passive access of the user of the transportation vehicle 10. In other words, the (authorized) user can enter or leave the transportation vehicle 10 without active intervention.

### REFERENCE SYMBOL LIST

10 Transportation vehicle
12 Control unit
14 First module
16 Second module
18 External transceiver
20, 20′ CAN interface
22, 22′ Transceiver
24, 24′ UWB/BLE antenna
26 NFC antenna
28 Third module
50 First method operation
52 Second method operation
54 Third method operation
56 Fourth method operation
58 Fifth method operation
60 Sixth method operation
100 System

1. A system comprising:
first and second modules each configured to detect a position of a user, wherein each module includes a transceiver having an antenna to transmit and receive UWB and BLUETOOTH® signals; and
a control unit connected to the transceivers, the control unit being configured to:
control receipt of a radio signal emitted via an external transceiver to authorize the user using at least one of the antennas;
control activation of the transceivers to transmit UWB impulses and receipt of impulse responses using at least one of the antennas and/or to perform method operations based on channel impulse response measurements using the antennas;
determine a position and/or a movement gradient of the user based on the received impulse responses and/or a result of channel impulse response (CIR) measurements, and
authenticate the user by assigning the user to the received radio signal based on the determined position and/or the determined movement gradient of the user.

2. The system of claim 1, wherein the control unit is further configured to control activation of the transceivers of the two modules to perform a positioning method based on delay measurements using the antennas to determine a position of the external transceiver;
wherein the user is further authenticated by matching the determined position and/or the determined movement gradient of the user with the determined position of the external transceiver.

3. The system of claim 1, wherein at least one of the transceivers further comprises an NFC antenna to transmit and receive NFC radio signals and to receive the radio signal for authorizing the user as an NFC radio signal.

4. The system of claim 1, wherein the control unit is further configured to determine an authorization status of the authenticated user based on the received radio signal and a database stored in a memory.

5. The system of claim 1, wherein the modules are arranged so the activation of the transceivers to perform the method based on the channel impulse response measurements and/or the transmission of the UWB impulses and reception of the impulse responses is/are carried out in such a way that at least one access area to the transportation vehicle is scanned.

6. A transportation vehicle including the system of claim 1, wherein the two modules are arranged on a vehicle side of the transportation vehicle, which has an access area for getting in and out of the transportation vehicle.

7. The transportation vehicle of claim 6, wherein at least one of the two modules is arranged at a maximum distance of 20 cm from the access area.

8. The transportation vehicle of claim 6, wherein the control unit is further configured to control opening at least one vehicle door and at least one vehicle window of the transportation vehicle based on the authorization status of the authenticated user.

9. The transportation vehicle of claim 6, wherein the control unit is further configured to control activation of the two modules to transmit a request for a payment procedure using the antennas and/or the at least one NFC antenna in response to the determined position of the authenticated user falling below a predetermined distance to the transportation vehicle, receipt of a confirmation signal to perform the payment procedure using the antennas and/or the at least one NFC antenna, and adaptation of the authorization status of the authenticated user based on the received confirmation signal.

10. A method for authenticating a user of a transportation vehicle, wherein the transportation vehicle has two modules to detect a position of a user, in each case having a transceiver to transmit and receive UWB and BLUETOOTH® signals, in each case having an antenna, the method comprising:
receiving a radio signal emitted via an external transceiver to authorize the user using at least one of the antennas;
activating the transceivers to transmit UWB impulses and to receive impulse responses using at least one of the antennas and/or to perform a method based on channel impulse response (CIR) measurements using the antennas;
determining the position and/or a movement gradient of the user based on the received impulse responses and/or a result of the CIR measurements; and
authenticating the user by assigning the user to the received radio signal based on the determined position and/or the determined movement gradient of the user.

11. The method of claim 10, further comprising:
activating the transceivers of the two modules to perform a positioning method based on delay measurements using the antennas to determine a position of the external transceiver;
wherein the user is further authenticated by matching the determined position and/or the determined movement gradient of the user with the determined position of the external transceiver.

12. The method of claim 10, wherein at least one of the transceivers further comprises an NFC antenna to transmit and receive NFC radio signals and to receive the radio signal for authorizing the user as an NFC radio signal.

13. The method of claim 10, further comprising:
determining an authorization status of the authenticated user based on the received radio signal and a database stored in a memory.

14. The method of claim 13, further comprising:
activating the two modules to transmit a request for a payment procedure using the antennas and/or the at least one NFC antenna in response to the determined position of the authenticated user falling below a predetermined distance to the transportation vehicle;
receiving a confirmation signal to perform the payment procedure using the antennas and/or the at least one NFC antenna; and
adapting the authorization status of the authenticated user based on the received confirmation signal.

15. The method of claim 13, further comprising:
opening at least one vehicle door and at least one vehicle window of the transportation vehicle based on the authorization status of the authenticated user.

16. The method of claim 10, wherein the modules are arranged so the activation of the transceivers to perform the method based on the channel impulse response measurements and/or the transmission of the UWB impulses and reception of the impulse responses is/are carried out in such a way that at least one access area to the transportation vehicle is scanned.
